(19) United States
(12) Patent Application Publication
(10) Pub. No.: US 2012/0021340 A1
(43) Pub. Date: Jan. 26, 2012

(54) FABRICATION METHOD FOR ENHANCING THE ELECTRICAL CONDUCTIVITY OF BIPOLAR PLATES

(75) Inventors: Shia-Chung Chen, Taoyuan County (TW); Jen-An Chang, Taoyuan County (TW); Ming-Yi Shih, Taichung County (TW)

(73) Assignee: CHUNG YUAN CHRISTIAN UNIVERSITY, Taoyuan County (TW)

(21) Appl. No.: 13/166,320

(22) Filed: Jun. 22, 2011

(30) Foreign Application Priority Data
Jul. 22, 2010 (TW) 099124170

(51) Int. Cl. H01M 8/00; B32B 38/16

(52) U.S. Cl. 429/535; 156/273.3

(57) ABSTRACT

A fabrication method for enhancing the electrical conductivity of bipolar plates, adapted for laminating a three-layered structure that is constructed by sandwiching a bonding layer made of a conductive material between two bipolar plates made of a thermoplastic polymer composite, is disclosed, which comprises the steps of: using an induction coil to heat up the bonding layer; and exerting a pressure upon the two bipolar plates for laminating the bonding layer to the two bipolar plates. With the aforesaid method, not only the through-plane conductivity with regard to the two bipolar plates can be enhanced, but also the processing time is greatly reduced.

### CROSS-REFERENCE TO RELATED APPLICATION

This non-provisional application claims priority under 35 U.S.C. §119(a) on Patent Application No. 099124170 filed in Taiwan (R.O.C.) on Jul. 22, 2010, the entire contents of which are hereby incorporated by reference.

### FIELD OF THE INVENTION

The present invention relates to a technique for fabricating fuel cell bipolar plates, and more particularly, to a fabrication method adapted for laminating a three-layered structure that is constructed by sandwiching a bonding layer made of a conductive material between two bipolar plates and thus enhancing the electrical conductivity of bipolar plates, that is advantageous in its good heating efficiency, low energy consumption and satisfactory through-plane conductivity of the two bipolar plates.

### BACKGROUND OF THE INVENTION

With rapid advance of our civilization, the consumption of conventional energies, such as coal, oil and natural gases, are increasing in an alarming rate, and consequently not only the pollution to our living environment is aggravating, but also the factors causing global warning and environment deterioration, such as the greenhouse effect and acid rain, are worsening. Nowadays, it is clear that there is only a limited amount of natural energy supply available, and it will be depleted in the near future if our unrestricted use of energy continues. Accordingly, alternative energy is a primary focus for most countries in the world since it can significantly reduce the amount of toxins that are by-products of energy use without the undesirable consequences of the burning of fossil fuels, such as high carbon dioxide emissions. Among all those alternative energy sources that are developping, fuel cell stack is selected to be the most promising energy source with practical value. Comparing with conventional Internal combustion engine using fossil fuels, fuel cell stack is advantageous in its high energy conversion efficiency, little or even zero high carbon dioxide emission, low noise level, and zero fossil fuel consumption.

Generally, a fuel cell is composed of three primary components, that is, electrode, electrolyte membrane and bipolar plate, and a fuel cell stack is made by serially connecting a plurality of such single fuel cells into a battery set. Consequently, the bipolar plates the serial-connecting conductive components in the fuel cell stack that act as an anode for one cell and a cathode for the next cell.

The bipolar plates, being an important component constructing a fuel cell stack that occupies a large proportion of the size and weight of the fuel cell stack, have a number of functions within the fuel cell stack, including: separating gases between cells; providing a conductive medium between the anode and cathode; providing a flow field channel for the reaction gases; and transferring heat out of the cell. Thus, bipolar plates required the following characteristics: good electrical conductivity, impermeable to gases, resistance to corrosion, resistance to high temperature, good mechanical properties, and so on.

Although there are some fuel cells whose bipolar plates are made of metal that have good electrical conductivity and good mechanical properties, they can be short in that: it is difficult to form microstructures on a metal bipolar plate. Therefore, with the progress of fuel cell technology, the most popular for making bipolar plate is composite materials.

There are already many researches efforting for producing better bipolar plates. One of which is a bipolar plate manufacturing method, disclosed in TW Pat. Pub. No. 399348, which shows a bipolar plate made from a mixture of a conductive material, a resin and a hydrophilc agent that is adapted for proton exchange membrane fuel cells.

Another such research is disclosed in U.S. Pat. No. 6,248,467, which shows a bipolar plate for fuel cells consists of a molded mixture of a vinyl ester resin and graphite powder.

Moreover, there is a bipolar plate manufacturing process disclosed in TW Pat. Pub. No. 1293998, entitled “MANUFACTURING PROCESS OF HIGH PERFORMANCE CONDUCTIVE POLYMER COMPOSITE BIPOLAR PLATE FOR FUEL CELL”, in which a bipolar plate is made of a mixture of graphite powder, a vinyl ester resin and polyetheramine-intercalated organoclay.

It is noted that all the aforesaid bipolar plates are made of different composite materials that they all have the following advantages: good resistance to corrosion and easy to have complex microstructures to be formed thereon.

Since there will be heat being generated from the electrochemical reaction of a fuel cell that must be transferred out of the fuel cell for enabling the fuel cell to maintain a proper working temperature, it is required for the bipolar plates of the fuel cell to be designed with satisfactory heat dissipating ability. Conventionally, such heat dissipation is achieved by sandwiching a metal piece between two bipolar plates for enhancing heat dissipating ability of the bipolar plates. Generally, the combining of the bipolar plates and the metal piece is enabled by the use of a thermal compression process. In the thermal compression process, first, the two bipolar plates are preheated to a temperature ranged between a softening temperature and a melting temperature relating to a composite material; and then the metal piece is placed at a position between the two bipolar plates before exerting a pressure upon the structure of the two bipolar plates sandwiching the metal piece, while the whole structure is continuously being heated during the exerting of the pressure for laminating the metal piece to the two bipolar plates.

Nevertheless, since the aforesaid thermal compression process can be very time consuming that the whole process starting from the preheating to the completing of the compression may last from several minutes to several tens of minutes, it can be understood that it is possible to extremely improve the time cost performance relating to the manufacturing process. In addition, since the heating the of the whole bipolar plate structure must be continue through out the compression process, the energy cost of the manufacturing process can be a troubling issue. Hence, it is in need of an improved thermal compression process that can lower the manufacturing cost of bipolar plates.

Moreover, since the bipolar plates are acting as connectors between two fuel cells, they must be made of a material of good electrical conductivity, and it is especially important for two connecting bipolar plates to have good through-plane conductivity. Thus, it is in need of a technique for fabricating bipolar plates with satisfactory through-plane conductivity.

### SUMMARY OF THE INVENTION

In view of the disadvantages of prior art, the primary object of the present invention is to provide a fabrication method for enhancing the electrical conductivity of bipolar plates, performed by the steps of: using an induction coil to heat up the bonding layer; and exerting a pressure upon the two bipolar plates for laminating the bonding layer to the two bipolar plates. The aforesaid method is advantageous in its good heating efficiency, low energy consumption and satisfactory through-plane conductivity of the two bipolar plates.

To achieve the aforesaid object, the present invention provides a fabrication method for enhancing the electrical conductivity of bipolar plates, adapted for laminating a three-layered structure that is constructed by sandwiching a bonding layer made of a conductive material between two bipolar plates made of a thermoplastic polymer composite, is disclosed, which comprises the steps of: performing an induction heating operation by the use of an induction coil to heat up the bonding layer; and performing a compression operation for exerting a pressure upon the two bipolar plates for laminating the bonding layer to the two bipolar plates.

By the use of the induction coil to heat up the bonding layer, the bipolar plates can be heated to a specific temperature in a short period of time so as to prepare the same for the posterior compression operation, and thus the manufacturing cost can be greatly reduced as the overall process time for the manufacturing of the bipolar plates is shortened significantly. Moreover, it is noted that by the aforesaid induction heating and thermal compression, the resulting bipolar plates can have good through-plane conductivity.

In a preferred embodiment of the invention, the heating of the bonding layer is continued for enabling the bipolar plates to achieved a temperature within a specific temperature range before performing the compression operation, i.e. to achieve a temperature ranged between a softening temperature and a melting temperature of the bipolar plates under the pressure of the compression operation.

In a preferred embodiment of the invention, the compression operation further comprises the steps of: providing a top block and a bottom block at positions for receiving the three-layered structure of the two bipolar plates and the bonding layer therebetween; and enabling the pressure of the compression operation to be exerted upon the top and the bottom blocks.

In a preferred embodiment of the invention, the induction coil is a mobile induction coil capable of moving to a specific position surrounding the outer sides of the top and bottom blocks while being disposed corresponding to the bonding layer for the induction heating operation, and capable of moving away from the specific position after completing the induction heating operation.

In a preferred embodiment of the invention, the induction coil can be an internal induction coil that is embedded inside the top and the bottom blocks.

In a preferred embodiment of the invention, the top and the bottom blocks are made of a non-conductive material, such as bakelite and rubber, etc.

In a preferred embodiment of the invention, the bonding layer is made from a plate selected from the group consisting of: a stainless steel plate, a nickel plate and a copper plate.

In a preferred embodiment of the invention, the bonding layer is made of a material selected from the group consisting of: a nickel powder, a copper powder, a steel powder and the likes.

In a preferred embodiment of the invention, the bonding layer is made of a mixture of carbon fibers and metallic fibers including copper fibers, nickel fibers and the likes.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram illustrating the performing of an induction heating operation using a mobile induction coil according to an embodiment of the invention.

FIG. 2 is a schematic diagram illustrating the performing of a compression operation upon bipolar plates according to the present invention.

FIG. 3 is a sectional diagram illustrating the performing of an induction heating operation using an internal induction coil according to an embodiment of the invention.

FIG. 4 is a table illustrating the through-plane resistance of a conventional two-piece bipolar plate and that of a three-piece bipolar plate of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

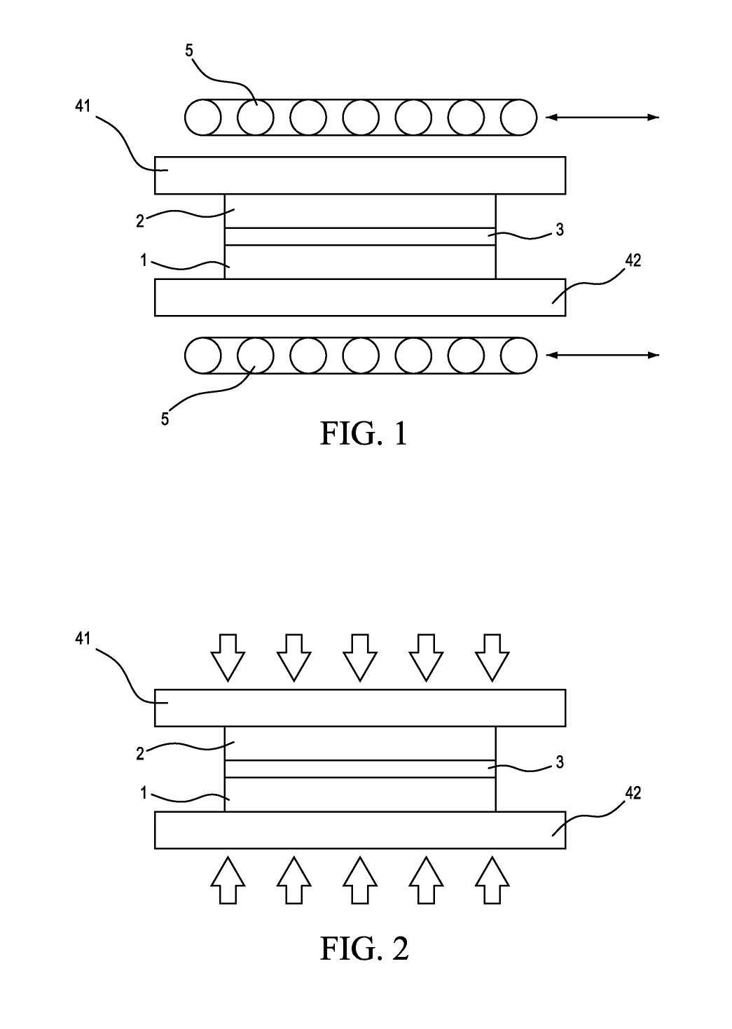

Please refer to FIG. 1 to FIG. 4, which are respectively a schematic diagram illustrating the performing of an induction heating operation using a mobile induction coil according to an embodiment of the invention; a schematic diagram illustrating the performing of a compression operation upon bipolar plates according to the present invention; a sectional diagram illustrating the performing of an induction heating operation using an internal induction coil according to an embodiment of the invention; and a table illustrating the through-plane resistance of a conventional two-piece bipolar plate and that of a three-piece bipolar plate of the invention.

The present invention relates to a fabrication method for enhancing the electrical conductivity of bipolar plates, adapted for laminating a three-layered structure that is constructed by sandwiching a bonding layer 3 between two bipolar plates 1, 2. The fabrication method comprises the steps of: performing an induction heating operation by the use of an induction coil to heat up the bonding layer; and performing a compression operation for exerting a pressure upon the two bipolar plates for laminating the bonding layer to the two bipolar plates. Moreover, by the use of the induction coil to heat up the bonding layer 3, the bipolar plates 1, 2 can be heated to a temperature within a specific temperature range before performing the compression operation, i.e. to achieve a temperature ranged between a softening temperature and a melting temperature of the bipolar plates 1, 2 under the pressure of the compression operation; and then the compression operation is performed for exerting a pressure upon the two bipolar plates 1, 2 so as to laminate the bonding layer 3 to the two bipolar plates.

In an embodiment shown in FIG. 1, the induction heating operation further comprises the steps of: providing a top block 41 and a bottom block 42 at positions for receiving the three-layered structure of the a first and a second bipolar plates 1, 2 and the bonding layer 3 therebetween while enabling the bonding layer 3 to be sandwiched between the two bipolar plates 1, 2; and then, moving a mobile induction coil 5 to a specific position surrounding the outer sides of the top and bottom blocks 41, 42 while being disposed corresponding to the bonding layer 3 for the induction heating the same; and finally moving the mobile induction coil 5 away from the specific position after completing the induction heating operation, i.e. as soon as the bipolar plates 1, 2 achieve a temperature ranged between a softening temperature and a melting temperature of the bipolar plates 1, 2 under the pressure of the compression operation.

In this embodiment, the bonding layer 3 can be made from a stainless steel plate, a nickel plate or a copper plate, etc.; or the bonding layer 3 can be made of a material selected from the group consisting of: a nickel powder, a copper powder, a steel powder and the likes; or the bonding layer is made of a mixture of carbon fibers and metallic fibers including copper fibers, nickel fibers and the likes.

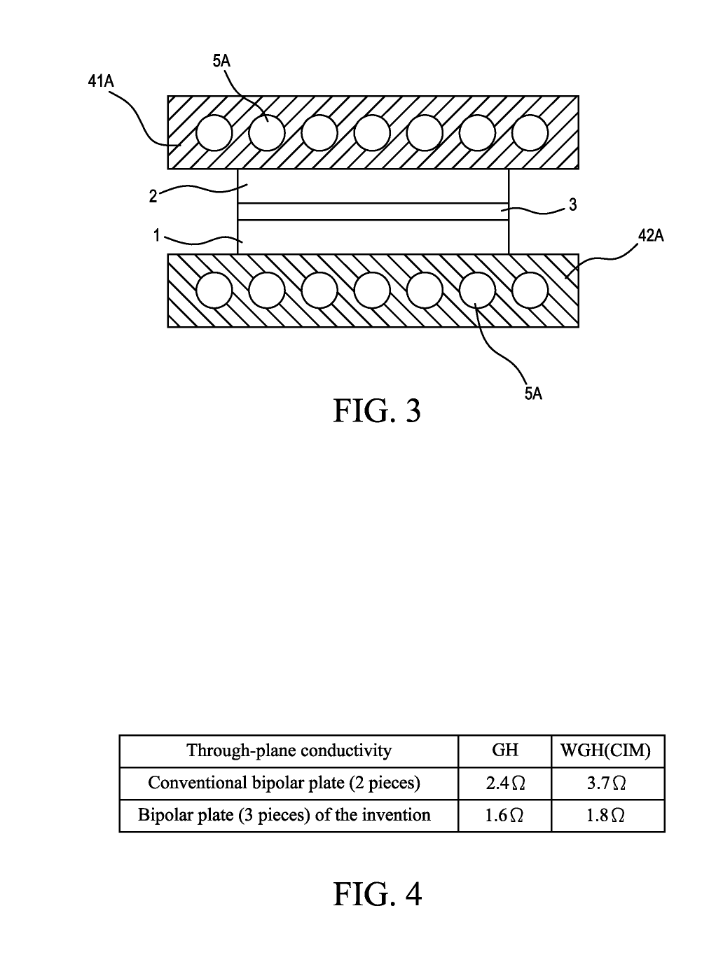

It is noted that other than the aforesaid mobile induction coil 5, the induction coil of the present invention can be an internal induction coil 5A, that is embedded inside the top and the bottom blocks 41A, 42A, as shown in FIG. 3. Accordingly, the top and the bottom blocks 41A, 42A should be made of a non-conductive material selected from the group consisting of: bakelite, rubber and the likes.

Moreover, the aforesaid first and second bipolar plates are made of a thermoplastic polymer composite that is a mixture of: phenylene sulfide, liquid crystal polyester, carbon fiber, graphite, and carbon black; and can be produced by a process selected from the group consisting of: a conventional injection molding process, a compression injection molding process, a gas assistance injection molding process, co-injection molding process and thermoforming process. It is noted that as long as the bipolar plates used in the present invention are made of a thermoplastic polymer composite, there is no other restriction relating to what are the materials used for forming the mixture of the thermoplastic polymer composite and what is the process selected for producing the bipolar plates.

No matter it is the mobile induction coil 5 or the internal induction coil 5A being used for heating the bonding layer 3, the induction heating operation should be control for enabling the two bipolar plates 1, 2 to achieve a temperature ranged between a softening temperature and a melting temperature of the bipolar plates 1, 2 under the pressure of the compression operation. It is importance not to exceed the melting temperature, since the overflowing of the thermoplastic polymer composite is likely to happen if the temperature exceeds the melting temperature of the two bipolar plates 1, 2.

After completing the induction heating operation, a compression operation is performed for exerting a pressure upon the top and the bottom blocks 41, 42 and thus pressing the three-layered structure of the first bipolar plate 1, the bonding layer 3 and the second bipolar plate 2 for laminating the bonding layer 3 to the two bipolar plates.

Since the method of the invention uses the induction coil 5 for induction heating the bonding layer 3 so that the power of the induction heating can be controlled according to the material of the bonding layer 3, and also the duration of the induction heating can be controlled considering the amount of energy used for the induction heating, the power consumption relating to the induction heating operation is reduced.

From an experimental data, it only take 10 to 20 seconds for the induction coil 3 to heat the bonding layer 3 to the specific temperature, and consequently, the whole process of the present invention including the compression operation performed upon the two bipolar plates will only take about 30 to 60 seconds, which is a greatly improvement comparing with the prior art that may last from several minutes to several tens of minutes. Thus, the fabrication method of the present invention clearly has advantages in good heating efficiency and low energy consumption so that the manufacturing cost of the method of the present invention is reduced.

As shown in FIG. 4, the data of column (a) are measured respectively from two bipolar plates produced by a gas assistance injection molding (GH) process and other two bipolar plates produced by a conventional injection molding (CIM) process. Moreover, during the measurement, the two bipolar plates are stacked for measuring its through-plane conductivity; and the result of the measurement is that: the through-plane conductivity relating to the bipolar plates produced by the GH process is 2.4Ω, and the through-plane conductivity relating to the bipolar plates produced by the CIM process is 3.7Ω. The foregoing two values of through-plane conductivity are used as benchmark for evaluating the performance of the fabrication method where the heating operation is performed by the use of induction coil, and also there is a bonding layer sandwiched between the bipolar plates.

In addition, the data of column (b) are measured respectively from a three-layered structure of a bonding layer sandwiched between two bipolar plates. Accordingly, the through-plane conductivity relating to the GH process is 1.6Ω while, the through-plane conductivity relating to the CIM process is 1.8Ω.

Comparing the data of column (a) and the data of column (b), the through-plane conductivity relating to the GH process is reduced from 2.4Ω to 1.6Ω while through-plane conductivity relating to the CIM process is reduced from 3.7Ω to 1.8Ω. Obviously, the through-plane conductivity relating to the bipolar plates produced from the fabrication method of the invention is greatly improved.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A fabrication method for enhancing the electrical conductivity of bipolar plates, adapted for laminating a three-layered structure that is constructed by sandwiching a bonding layer made of a conductive material between two bipolar plates made of a thermoplastic polymer composite, comprising the steps of:
performing an induction heating operation by the use of an induction coil to heat up the bonding layer; and
performing a compression operation for exerting a pressure upon the two bipolar plates for laminating the bonding layer to the two bipolar plates.

2. The fabrication method of claim 1, wherein the heating of the bonding layer is continued for enabling the bipolar plates to achieved a temperature within a specific temperature range before performing the compression operation, while the specific temperature range is a temperature range defined between a softening temperature and a melting temperature of the bipolar plates under the pressure of the compression operation.

3. The fabrication method of claim 1, wherein the compression operation further comprises the steps of:
providing a top block and a bottom block at positions for receiving the three-layered structure of the two bipolar plates and the bonding layer therebetween; and
enabling the pressure of the compression operation to be exerted upon the top and the bottom blocks.

4. The fabrication method of claim 3, wherein the induction coil is a mobile induction coil capable of moving to a specific position surrounding the outer sides of the top and bottom blocks while being disposed corresponding to the bonding layer for performing the induction heating operation, and capable of moving away from the specific position after completing the induction heating operation.

5. The fabrication method of claim 3, wherein the induction coil is an internal induction coil that is embedded inside the top and the bottom blocks.

6. The fabrication method of claim 3, wherein the top and the bottom blocks are made of a non-conductive material selected from the group consisting of: bakelite, rubber and the likes.

7. The fabrication method of claim 1, wherein the bonding layer is made from a plate selected from the group consisting of: a stainless steel plate, a nickel plate and a copper plate.

8. The fabrication method of claim 1, wherein the bonding layer is made of a material selected from the group consisting of: a nickel powder, a copper powder, a steel powder and the likes.

9. The fabrication method of claim 1, wherein the bonding layer is made of a mixture of carbon fibers and metallic fibers including copper fibers, nickel fibers and the likes.
